(19) United States
(12) Patent Application Publication
(10) Pub. No.: US 2012/0211410 A1
(43) Pub. Date: Aug. 23, 2012

(54) FILTER DEVICE

(76) Inventors: Ralf Wnuk, Bexbach/Kleinottweiler (DE); Martin Winter, Wadern (DE)

(21) Appl. No.: 13/261,261

(22) PCT Filed: Sep. 14, 2010
(86) PCT No.: PCT/EP2010/005631

§ 371 Date: Apr. 12, 2012

(30) Foreign Application Priority Data
Oct. 17, 2009 (DE) 10 2009 049 712.9

(51) Int. Cl. B01D 29/21

(52) U.S. Cl. 210/323.2; 210/457; 210/437

(57) ABSTRACT

The invention relates to a filter device, in particular for fluids such as hydraulic oil, lubricating media, processing, surface or sea water, having at least one filter element (3) that has at least one effective filter surface (23), which is suitable for removing contaminants from a media flow crossing the filter surface, wherein an effective filter surface is designed as a flexible filter sock (23) that can be pulled onto a support body (13) of the filter element (3). The invention is characterized in that the filter sock (23), while enlarging the effective filter surface thereof, is designed to be longer in the axial direction of the filter element (3) such that the effective filter surface lies in folds upon pulling the filter sock (23) over the support body (13).

The invention relates to a filter device, in particular for fluids such as hydraulic oil, lubricating media, process water, surface water, or sea water, comprising at least one filter element that has at least one effective filter surface that is suitable for absorbing contaminants from a medium flow traversing the filter surface, wherein an effective filter surface is provided in the form of a filter sock that can be pulled onto a support body of the filter element.

In systems and mechanical equipment which use flowable media as the operating medium, the operational reliability depends significantly on the perfect quality of the media involved. Therefore, especially in high-end systems and also for reasons relating to cost effectiveness, it is necessary to provide suitable filter devices for the media involved—be they gaseous media or fluids—in order to remove any contaminants that might occur under normal operating conditions. If the operating fluids involved are loaded with contaminants that contain solid particles or colloidal contaminants, the efficiency of the filter devices must meet very stringent requirements. Therefore, the conventional filter devices for such applications are complex in design. As a result, those systems that use such filters are significantly more complex in their entirety and, hence, cost more to manufacture and operate.

A filter device of the type described in the introductory part is known from EP 0 656 223 A1. This prior art backflushing device, which can be backflushed with the contaminated fluid that is to be filtered, has filter cartridges, which can be traversed by flow in the longitudinal direction and are arranged in the filter housing in such a way that they form a circle relative to each other. These filter cartridges are or can be connected to the filter inlet. For flushing purposes, one end of these filter cartridges, which can be connected individually or in groups, can be connected to a flushing element that is connected to a slurry outlet. Each filter cartridge consists of a support body with a star-shaped cross section and with six star tips having free ends that form the support edges for the filtering means that consists of a fabric hose. The fabric hose, forming the filtering means, is pulled over the support body like a sock that is open on both sides. During the filtering mode, both ends of the filter cartridges are connected to the filter inlet.

A filter cartridge comprising a more or less cylindrical support body for a filter device is known from DE 75 09 253 U. In addition, there are a filter fabric surrounding the support body, a port that is arranged on one front end of the filter cartridge for the filtrate outlet, and a cover that is arranged on the other front end and that seals off the filter cartridge. The filter fabric is pulled onto the support body as a prefabricated sock. In order to be able to pull the filter fabric onto the support body as free of creases as possible, it is expedient to arrange the rods of the support body in a slightly conical manner and to configure the filter fabric sock in a suitably conical manner. The wire, which acts as a helical thread and winds around the rods, enables a delicately sensitive expansion of the conical sock when the support body is rotated about the longitudinal axis relative to the filter fabric sock.

Working on the basis of the above prior art, the object of the present invention is to provide a filter device of the type described in the introductory part that is distinguished by a very simple design and high filtration performance and, irrespective thereof, meets the requirements for a filter device.

This object is achieved by a filter device having the features specified in claim 1 in its entirety.

In that, according to the characterizing part of claim 1, the filter sock is designed to be longer, when viewed in the axial direction of the filter element, by enlarging the effective filter surface of the filter sock, so that the effective filter surface lies in folds when the filter sock is pulled onto the filter element, it is possible to attain a filter device of high efficiency with minimal engineering effort and in a very compact design. The use of a filter sock that forms an effective filter surface and that can be pulled onto a support body involved also makes the production steps and assembly steps very simple, so that an efficient, inexpensive production of such a filter element is possible. Moreover, the steps involved in changing the filter medium are convenient and simple. In addition to the enlargement of the filter surface, the pleated aspect of the filter sock also contributes to the formation of gaps relative to the support body.

In this context, it can be provided in an especially advantageous way that the support body has an additional filter surface as the additional filtration step and that each filter surface exhibits a different filter fineness. This feature makes it possible to attain in an especially advantageous way two filtration steps in one and the same filter element, combined into a filter combination, so that both a prefiltration and a fine filtration can be carried out in one filter element.

When the filter sock is arranged on the exterior of the support body and when such a complemented filter element is traversed by flow from the outside to the inside, the filter sock can exhibit a lesser degree of filter fineness for the purpose of a coarse filtration step than the additional filter surface of the support body, whereas when the filter element is traversed by flow from the inside to the outside, the filter surface of the support body forms such a coarse filtration step.

It is especially advantageous that the fineness of the filter surfaces can be adapted in such a way that the prefiltration step traps, in particular contaminants in the form of solid particles, a feature that does not result in a significant increase in the flow resistance given the lesser degree of filter fineness in the prefiltration step, and, at the same time, the risk of a premature clogging of the fine filtration step due to the just previous removal of the solid particles is eliminated.

Preferably, the additional filter surface of the filter sock is arranged at a predefinable distance from the exterior of the support body of the filter element in such a way that in particular during the backflushing mode, wherein the medium flow flows in the reverse flow direction to that during the filtration mode, the contaminants are knocked out of the filter surface. Since the filter sock forms a loose cover, which does not fit tightly on the support body, the flow of the backflushing operation can generate a movement of the filter sock in the form of a flapping motion, so that contaminants which have reached the filter surface of the filter sock are shaken out. This operating behavior is supported by the fact that the width dimensions of the filter sock are chosen in such a way that the sock is located at a suitable distance from the filter surface at least during the backflushing mode.

The filter sock can be secured as a seamless filter fabric in an especially advantageous way with at least its two opposite ends exclusively at the end regions of the filter element. In this case, the filter fabric is constructed in the form of a single layer or multiple layers and can be made at least partially of a satin, twill, or linen fabric.

In this context, the filter sock can be made of polypropylene, polyester, or a lipophilic material such as polyolefin polyester or copolyester, or other non-polar materials that can also be applied on the filter sock as a coating. Moreover, in this case, hydrophilic and/or polar media can also be used for the filter sock structure.

The filter element can have in an especially advantageous manner a slotted hole screen tube filter element, which forms the support body and its effective filter surface and which is in the form of a conical shell having a contour that conforms to the pulled-on filter sock. Such a slotted hole screen tube filter element, which can be formed as a winding former made of metal or plastic, can form the structure of a type of filter cartridge, over which the filter sock is pulled without any additional components.

The arrangement can be configured in such an advantageous way that the effective filter surface of the support body—that is, for example, the slotted hole screen tube filter element—exhibits a filter fineness between 100 and 3,000 μm and that the effective filter surface of the filter sock exhibits a suitably adapted filter fineness between 10 and 150 μm.

Instead of exemplary embodiments, in which the filter element is traversed by flow from the interior to the exterior during the filtration mode, the arrangement in alternative exemplary embodiments can also be configured in such a way that the filter element is disposed in a filter housing in such a way that during the filtration mode the filter element can be traversed by flow from its exterior to an inner filter cavity.

In such exemplary embodiments, a prefiltration step can be implemented in such a way that the filter housing has a swirl chamber and that the medium flow to be filtered is routed around the filter element in a swirling flow so that this medium flow forms at least partially a cyclone. This feature facilitates the removal of particles by cyclone action before the medium flows through the filter surface of the filter sock.

The inventive device, comprising a filter element with a filter sock, can also be used especially advantageously in backflushing filter devices with a plurality of filter element arrangements, of which at least one filter element arrangement can be backflushed, as described for example, in the document WO 98/42426, while the other filter element arrangements are used to filter the medium flow.

The invention is explained in detail below by means of exemplary embodiments that are depicted in the drawings. Referring to the drawings:

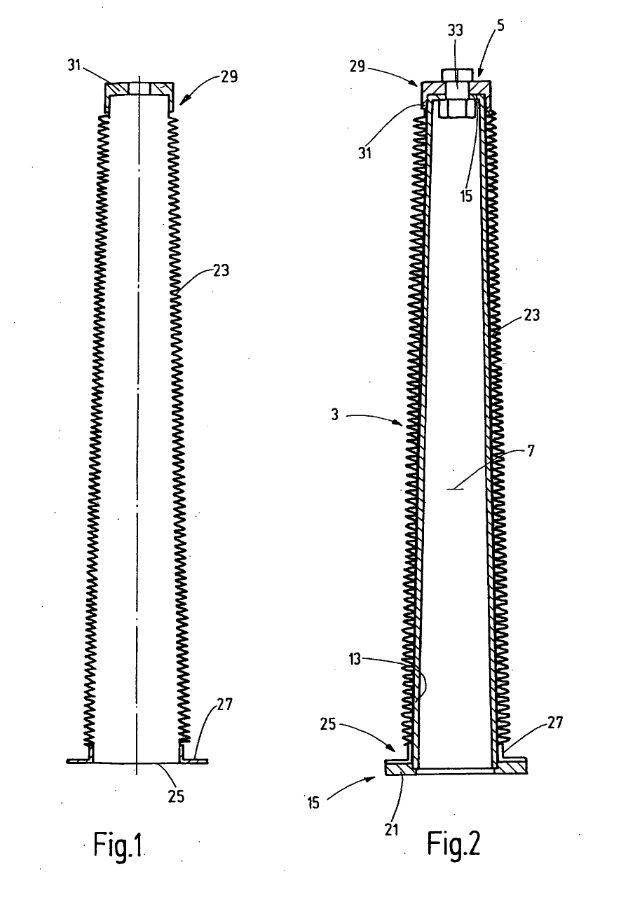

FIG. 1 shows in schematic form a highly simplified longitudinal view of the filter sock for the exemplary embodiments of the filter device to be described;

FIG. 2 shows in schematic form a highly simplified longitudinal view of a single isolated filter element with a support body, which is formed by a slotted hole screen tube filter element, which forms the filter surface and over which the filter sock from FIG. 1 is pulled;

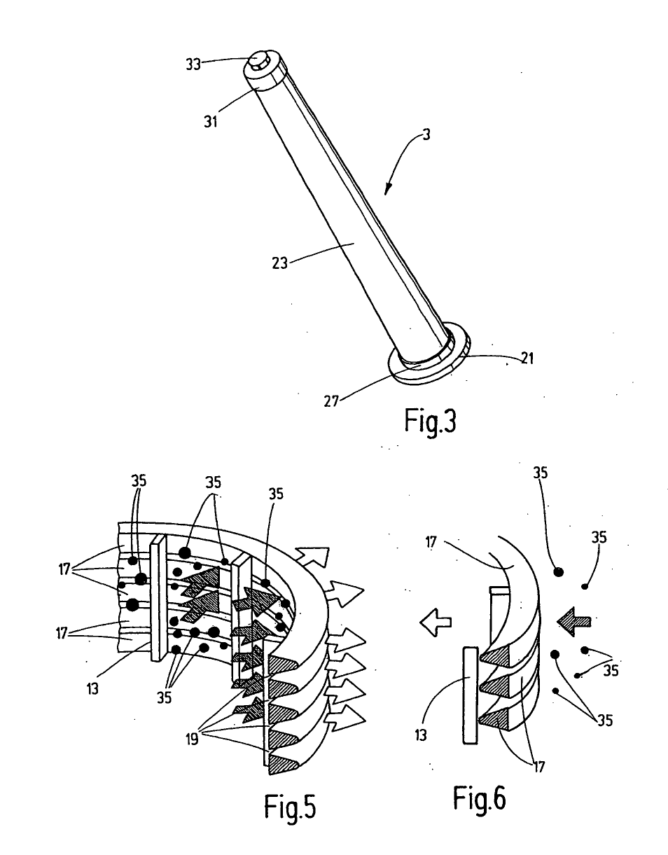

FIG. 3 is a perspective oblique view of the filter element drawn on a smaller scale than in FIGS. 1 and 2;

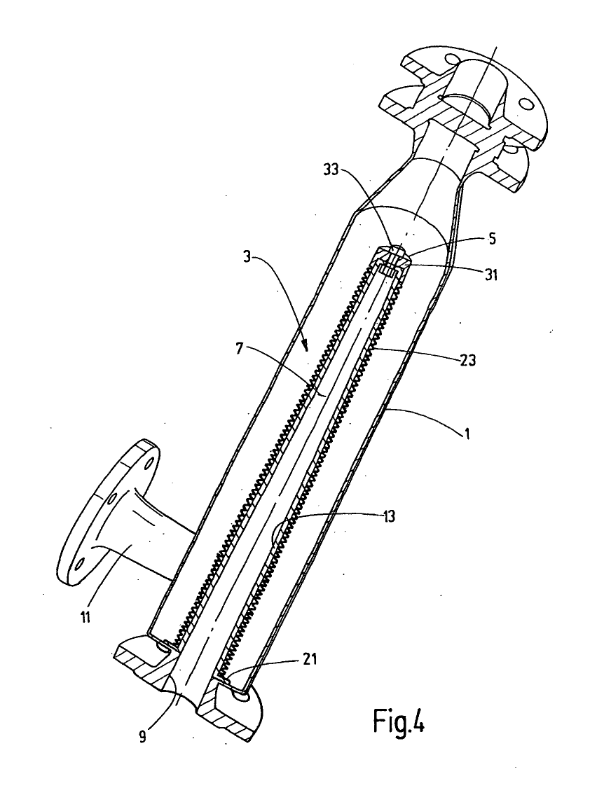

FIG. 4 shows in schematic form a highly simplified perspective oblique view of a first exemplary embodiment of the filter device that is partially cut open lengthwise with the filter element from FIGS. 2 and 3 inserted therein;

FIG. 5 shows a fragment of a wall section of the slotted hole screen tube filter element of the exemplary embodiment, where this fragment has not been drawn to scale, but rather enlarged to elucidate the operating principle of the first exemplary embodiment;

FIG. 6 shows a fragment of an alternative exemplary embodiment that is similar to the embodiment in FIG. 5, but has been highly simplified in the form of a schematic in order to elucidate the operating principle of this alternative embodiment; and

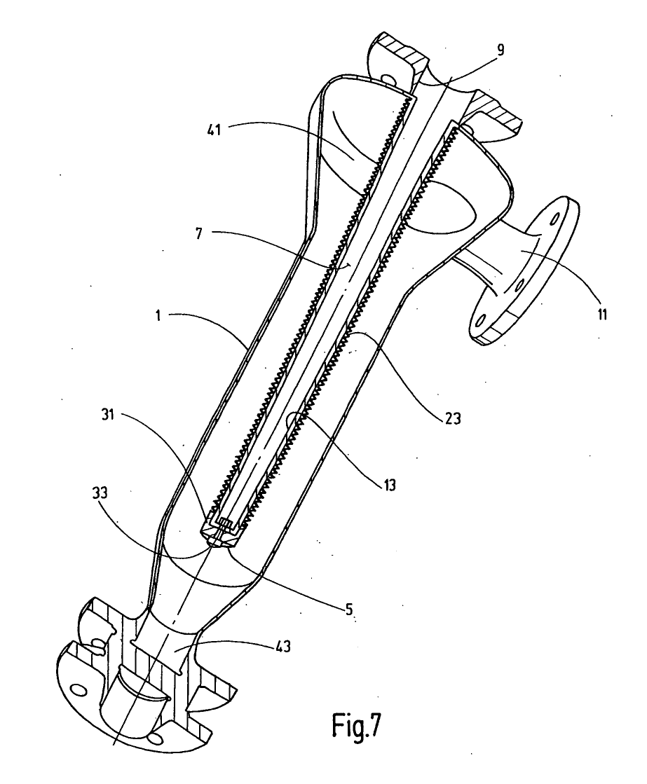

FIG. 7 is a perspective oblique view of a second exemplary embodiment of the filter device and, inserted therein, the filter element, which can be traversed by flow from the exterior to the interior during the filtration mode and which is depicted in FIGS. 2 and 3; and in this case the second embodiment of the filter device is similar to the one in FIG. 4, but is highly simplified in schematic form and partially cut lengthwise.

To begin with, the invention is explained below by means of one example of a filter device with reference to the FIGS. 1 to 5, where the filter housing, designated as 1 in FIG. 4, contains a filter element, designated as a whole as 3. The filter element is designed in the manner of a so-called filter cartridge and forms two filtration steps when the device is running. In this example, the filter element 3 exhibits a slightly conically tapered shape toward the closed end 5. However, the invention can be implemented just as well with filter elements exhibiting a cylindrical shape. FIG. 4 is a highly simplified view in schematic form of a filter element 3 that is disposed in the housing 1 in such a way that the inner filter cavity 7 borders on a housing opening 9, which is located at an axial end of the filter housing 1 and forms the inflow opening during the filtration mode. A lateral housing port 11 forms the outlet for the cleaned medium during the filtration mode. More details about the exemplary embodiment of the filter element 3 to be described herein may be found especially in FIGS. 1 to 3 and 5. It is clear that the slotted hole screen tube filter element 13 surrounds the inner filter cavity 7 in the form of a conical support body in such a way that the filter cavity 7 is closed at the upper end 15 (FIG. 2). The slotted hole screen tube filter element 13 is constructed in the manner known from the prior art in the form of a winding former with windings, which are designated as 17 in FIG. 5 and which are formed by strands of stainless steel or plastic, in such a way that between the windings 17 there are gaps 19, which form the one effective filter surface, when the element 3 is traversed by flow in the flow direction, indicated in FIG. 5, during the filtration mode. In this case, the width of the gap 19 is chosen so that the effective filter surface of the slotted hole screen tube filter element 13 corresponds to a filter fineness that forms a prefiltration step with a filter fineness that can lie in a range from 100 to 3,000 μm. FIGS. 2 and 3 show very clearly that the open end of the slotted hole screen tube filter element 13 has an annular flange 21, which forms, following the housing opening 9, an insert into the filter housing 1.

In order to complete the filter element 3, which is shown separately and in its completed state in FIG. 3, a filter sock 23, shown separately in FIG. 1, is provided for the purpose of forming a fine filtration step. This filter sock has an open end 25 with an end sealing ring 27. The filter sock 23 is pulled onto the slotted hole screen tube filter element 13 as its cover so that the end sealing ring 27 rests against the annular flange 21 of the slotted hole screen tube filter element 13 and is fastened thereto, for example, by means of adhesive cementing. In this way, the slotted hole screen tube filter element 13 forms the support body for the whole filter element 3. The drawing shows at the upper end 29 of the filter sock 23 that an end cap 31, which closes off the filter sock 23, is connected to the assigned end of the slotted hole screen tube filter element 13 by means of a screw 33.

Whereas in FIG. 3 the filter element 3 is shown with a filter sock 23, forming a smooth surface, FIGS. 1, 2, and 4 show that the length of the filter sock 23 is chosen preferably larger than the axial length of the slotted hole screen tube filter element 13. Therefore, in the case of the filter sock 23, which is pulled onto the slotted hole screen tube filter element 13, the sock 23 lies in folds, as shown in the drawing, so that, as shown, folds can be formed in the manner of pleats. Hence, in contrast to a smooth contour of the surface of the sock 23, the folds significantly increase the surface area. That is, the folds produce an extremely large and effective filter surface of the effective filter surface, which is formed by the filter sock 23 and which serves as the after-filtration or fine filtration step. In addition, owing to the fold formation or the pleats, the filter sock 23 does not lie flat—that is, not without forming spaces or gaps—on the exterior of the slotted hole screen tube filter element 13, a feature that is an important factor for the operating behavior that is described below.

In order to operate as an after-filtration or fine filtration step, the filter sock 23 is formed preferably by a seamless filter fabric, which is secured only on the two ends 25 and 29. In this respect, the filter fabric can consist of a single layer or multiple layers, which can be a satin fabric, twill fabric, or linen fabric. For a filter fineness that is significantly higher than that of the slotted hole screen tube filter element 13—that is, for example, in a range between 10 and 80 μM—a suitable diameter for the warp threads of the fabric lies in a range of 50 μm, and a suitable diameter for the weft threads is in a range of 400 μm. In addition to conventional materials for the filter fabric, such as polypropylene or polyethylene, it is possible to provide for the filter sock lipophilic materials, such as polyolefin, polyester or copolyester, as well as other non-polar materials. Such materials can also be applied as additional material in the form of a coating on the fabric of the filter sock 23.

During the filtration mode, in which the medium flow flows through the opening 9 of the filter housing 1 and enters into the inner filter cavity 7 of the filter element 3, the slotted hole screen tube filter element 13 forms, as stated above, an effective filter surface with the gaps 19 between the windings 17 (see FIG. 5). In accordance with the filter fineness formed by the distances between the windings 17, the slotted hole screen tube filter element 13 serves as the prefilter, which retains, in particular, the solid particles, which are indicated in FIG. 5 and marked with the reference numeral 35 only in certain areas. Then the fine filtration follows in accordance with the higher filter fineness of the effective filter surface formed by the filter sock 23. In this context, contaminants are retained in the interspace between the slotted hole screen tube filter element 13 and the folds of the filter sock 23; and the cleaned medium exits through the port 11 and out of the filter housing 1.

The filter device according to the invention lends itself especially well to a backflushing of the filter element 3. For purposes of a backflushing operation, the flow direction of the medium flow is reversed, so that the flushing flow enters via the port 11 in order to flow through the filter element 3 from the exterior to the interior. Solid particles clinging to the interior of the slotted hole screen tube filter element 13 are washed off and flushed out through the housing opening 9. As stated above, the distance formed by the folds of the filter sock 23 or, as a result of the choice of the dimensions, the additional distance between the slotted hole screen tube filter element 13 and the filter sock 23 is an important factor and, in particular, with respect to the backflushing operation. Since the filter sock 23 rests loosely on the slotted hole screen tube filter element 13, the result during the backflushing operation is a flow effect that leads to movements of the filter sock 23—stated more succinctly—flapping movements of the pleated folds. As a result, the contaminants on the filter sock 23 are shaken off, and at the same time the filter sock is consequently cleaned.

FIGS. 6 and 7 elucidate an alternative example, wherein, as indicated in FIG. 6, the direction of the medium flow is directed from the exterior to the interior during the filtration mode. As shown in FIG. 6, the support body 13 in turn is designed, as the slotted hole screen tube filter element, with windings 17. The slotted hole screen tube filter element forms a fine filtration step, whereas in this flow direction the pulled-on filter sock 23 (not visible in FIG. 6) forms an upstream prefiltration step and takes over the coarse filtration.

FIG. 7 shows that this exemplary embodiment implements an optimized bypass of the filter element 3 in that the filter housing 1 in the region of the flow inlet forms via the port 11 a cyclone. For this purpose, the filter housing 1 is expanded conically at the port 11, through which the medium flows in tangentially to the housing wall, in such a way that a swirl chamber 41 is formed. In this swirl chamber, the medium to be filtered is routed around the filter element 3 in a swirling flow so as to form the cyclone. Such a solution can also be backflushed again by reversing the fluid direction. In particular, when backflushing the filter sock 23, the folds of the filter sock and/or a correspondingly elastic material structure may cause the filter sock to expand, so that the dirt attached to said filter sock is thrown off. In this way, a cleanable surface filter can be attained.

1. A filter device, in particular for fluids such as hydraulic oil, lubricating media, process water, surface water, or sea water, comprising at least one filter element (3) that has at least one effective filter surface (23) that is suitable for absorbing contaminants from a medium flow traversing the filter surface, wherein an effective filter surface is designed as a flexible filter sock (23) that can be pulled onto a support body (13) of the filter element (3), characterized in that by enlarging the effective filter surface of the filter sock, the filter sock (23) is designed to be longer, when viewed in the axial direction of the filter element (3), so that the effective filter surface lies in folds when the filter sock (23) is pulled onto the support body (13).

2. The filter device according to claim 1, characterized in that the support body (13) has an additional filter surface (17, 19) as the additional filtration step and that each filter surface (23; 17, 19) exhibits a different filter fineness.

3. The filter device according to claim 2, characterized in that the filter sock (23) is arranged on the exterior of the support body (13) and that when such a complemented filter element (3) is traversed by flow from the outside to the inside, the filter sock (23) exhibits a lesser degree of filter fineness for the purpose of a coarse filtration step than the additional filter surface of the support body (13), and that when the filter element (13) is traversed by flow from the inside to the outside, the filter surface of the support body (13) forms such a coarse filtration step.

4. The filter device according to claim 2, characterized in that the filter surface of the filter sock (23) is arranged at a predefinable distance from the exterior of the support body (13) of the filter element (3) in such a way that when the filter element (3) is traversed by flow from the exterior to the interior, the contaminants are knocked out of the filter surface.

5. The filter device according to claim 1, characterized in that the filter sock (23) is secured as a seamless filter fabric with at least its two opposite ends (5, 15) exclusively at the end regions of the support body (13) of the filter element.

6. The filter device according to claim 5, characterized in that the filter fabric is constructed in the form of a single layer or multiple layers and is made at least partially as a satin fabric, twill fabric, or linen fabric.

7. The filter device according to claim 1, characterized in that the filter sock (23) is made of polypropylene, polyester, or a lipophilic material, such as polyolefin polyester or copolyester, or other non-polar materials that can also be applied on the filter sock (23) as a coating.

8. The filter device according to claim 2, characterized in that the filter element (3) has a slotted hole screen tube filter element (13), which forms the support body and its effective filter surface (17, 19) and which is in the form of a conical shell having a contour that conforms to the pulled-on filter sock (23).

9. The filter device according to claim 2, characterized in that the effective filter surface (17, 19) of the support body (13) of the filter element (3) exhibits a filter fineness between 100 and 3,000 μm and that the effective filter surface of the filter sock (23) exhibits a suitably adapted filter fineness between 10 and 150 μm.

10. The filter device according to claim 1, characterized in that the filter element (3) is disposed in a filter housing (1) in such a way that during the filtration mode, the filter element (3) can be traversed by flow from its exterior to an inner filter cavity (7).

11. The filter device according to claim 10, characterized in that the filter housing (1) has a swirl chamber (41), so that the medium flow to be filtered is routed around the filter element (3) in a swirling flow so that this medium flow forms at least partially a cyclone.

12. The filter device according to claim 1, characterized in that a filter element arrangement, comprising a filter element (3) with a filter sock (23), is used in backflushing filter devices with a plurality of filter element arrangements, of which at least one filter element arrangement (3, 23) can be backflushed, while the other filter element arrangements (3, 23) serve to filter the medium flow.
